(19) United States
(12) Patent Application Publication
(10) Pub. No.: US 2012/0075121 A1
(43) Pub. Date: Mar. 29, 2012

(54) Airport incursion notification system

(76) Inventors: Michael J. O'Hara, Bellingham, MA (US); Michael Willis, Boxborough, MA (US)

(21) Appl. No.: 13/200,468

(22) Filed: Sep. 23, 2011

Related U.S. Application Data
(60) Provisional application No. 61/404,012, filed on Sep. 24, 2010.

(51) Int. Cl. G08G 5/04

(52) U.S. Cl. 340/961

(57) ABSTRACT

An airport incursion notification system includes a fiber optic configured as an interferometric sensor to detect noise and buried adjacent at least at select runways and taxiways of an airport. At least one interrogator unit is for determining the location of and classifying noises detected by the fiber optic. Indicators are present at least at select runway and taxiway intersections. A controller subsystem is responsive to the interrogator unit and is configured to activate one or more indicators if an incursion condition exists. Imaging and/or radar subsystems can also be employed.

### RELATED APPLICATIONS

This application hereby claims the benefit of and priority to U.S. Provisional Application Ser. No. 61/404,012 filed on Sep. 24, 2010 under 35 U.S.C. §§119, 120, 363, 365, and 37 C.F.R. §1.55 and §1.78 and incorporated herein by this reference.

### FIELD OF THE INVENTION

The subject of the invention relates to airport incursions.

### BACKGROUND OF THE INVENTION

Incursions at airports include, inter-alia, one aircraft entering a runway or taxiway already occupied or about to be occupied by another aircraft, vehicles colliding with planes or other vehicles, and planes or vehicles colliding with people, wildlife, or objects on runways and taxiways. At night or in poor visibility conditions, the chance of an incursion increases especially at airports with multiple runways, taxiways, and high traffic levels.

The incursion problem has been studied and numerous solutions proposed and yet runway incursion incidents are increasing. See the FAA's various reports and briefings at www.faa.gov/airports/runway safety. See also US Published Publication Nos. 2004/0225440 and 2002/0163461 incorporated herein by this reference.

Systems relying on radar are expensive and may require the air traffic controller to interpret the radar data. Airport surface detection equipment such as the “ASDE-X” system uses the data from several surveillance solutions to determine aircraft and vehicle positions and identification (where possible). But, this system is expensive, has an undesirable false alarm rate, and undesirable error margins regarding positional information.

Others have proposed various types of individual sensors located at the airport such as rows of magnetometers in the taxiways (US Published Application No. 2010/0023191); inductive loop sensors (US Published Application No. 2003/0009278); and motion detectors (US Published Application No. 2002/0163461). All these references are also included herein by this reference.

### BRIEF SUMMARY OF THE INVENTION

In accordance with examples of the subject invention, a lower cost, scalable solution is provided to assist in the prevention of runway and other incursions by providing detection capability that can operate in all weather conditions and lighting conditions, which does not require aircraft equipment installation, testing, or certification, and which acts independently. In one preferred embodiment, the system provides a high degree of accuracy regarding aircraft physical position in relation to active runways and has a low false alarm rate.

This invention features, in one example, an airport incursion notification system comprising a fiber optic cable configured as an interferometric sensor to detect noise and buried adjacent at least at select runways and also typically the taxiways of an airport. At least one interrogator unit is provided for determining the location of and classifying noises detected by the fiber optic. Indicators are located at select runway and taxiway intersections. A controller subsystem is responsive to the interrogator unit and is configured to activate one or more of the indicators if an incursion condition exists.

In one version, the fiber optic cable is set along opposite sides of at least select runways and/or taxiways and the indicators include above ground warning lights. Other indicators include runway entrance lights, take off hold lights, runway intersection lights, and even precision approach path indicator lights.

In one example, an incursion condition includes a plane on a runway and in response the controller subsystem is configured (e.g., programmed) to activate indicators at taxiways intersecting with that runway. In another example, an incursion condition includes a vehicle on a runway and in response the controller subsystem is configured to activate runway based indicators. In still another example, an incursion condition includes a plane on a taxiway intersecting a runway and a plane, vehicle, or other object on said runway and the controller subsystem is configured, in response, to activate an indicator at the taxiway where it intersects the runway. Another incursion condition includes a plane or vehicle on one taxiway and a plane, vehicle, or object on an intersecting taxiway and the controller subsystem is configured to activate an indicator at the taxiway intersection.

In more complex systems, a high resolution imager is provided and the controller subsystem can be configured to activate the high resolution imager in response to an incursion condition. Also, a radar subsystem can be added, such as a millimeter wave radar subsystem, and the controller subsystem is then typically also configured to activate the radar subsystem in response to an incursion condition.

One system in accordance with the invention includes an acoustic sensor subsystem set along at least at a select runway and typically a taxiway of an airport. Indicators are located at least at select runway and taxiway intersections and a controller subsystem is responsive to the acoustic sensor subsystem and configured to activate one or more of the indicators if an incursion condition exists. In one preferred embodiment, the acoustic sensor subsystem is set alongside the runways and taxiways, e.g. buried alongside them. One preferred acoustic sensing subsystem includes a fiber optic cable configured as an interferometric sensor and the acoustic sensing subsystem may further include at least one interrogator unit configured to detect the location of and classify noises detected by the fiber optic cable.

The invention may also include a method comprising setting along one or more runways and typically also one or more taxiways of an airport an acoustic sensor subsystem, providing indicators located at least at select runway and taxiway intersections, and linking the acoustic sensor subsystem to the indicators. One or more of the indicators are then activated if an incursion condition exists as detected by the acoustic sensor subsystem. A fiber optic cable can be buried alongside opposite sides of at least select runways and/or taxiways. Typically, the indicators are configured as above ground warning lights.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a fairly simple airport layout with one version of an airport incursion notification system installed at the airport in accordance with an example of the invention;

FIG. 2 is a schematic view showing a more complex airport environment also equipped with an example of an airport incursion notification system of the invention;

FIG. 3 is a schematic view of yet another airport environment equipped with the incursion notification system;

FIG. 4 is a block diagram showing the primary components associated with one example of an incursion notification system in accordance with the invention;

FIG. 5 is a flow chart depicting the operation of the software operating on the controller subsystem shown in FIG. 4; and

FIG. 6 is a flow chart depicting operation of the system in accordance with an example of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

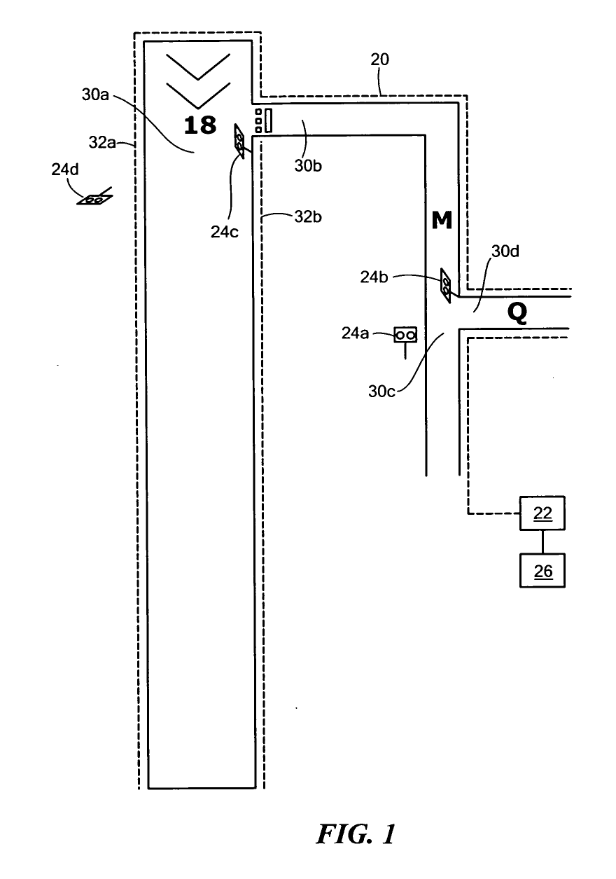

FIG. 1 depicts a fairly simple airport layout with taxiway “Mike” and intersecting taxiway “Quebec” leading to the near or approach end of runway 18. An airport incursion notification system in accordance with one example of the invention includes fiber optic 20 optionally buried adjacent taxiways “Q” and “M” as shown and typically about the majority of both sides of runway 18. Fiber optic 20 is preferably configured as interferometric sensor to detect noise, classify objects based on their acoustic signature, and to define the location of the objects based on their acoustic signature. See US Published Application No. 2006/0257066 and GB 2 136 113A incorporated herein by this reference. In one example, the distributed acoustic sensing subsystem may also include interrogator unit 22. The fiber optic may continue from one location to another about the various runways and taxiways or may even form a loop. Other sensor subsystems are also possible.

Indicators 24a, 24b, 24c, 24d and the like are also provided, typically configured as above ground light bars on posts each including one or more red lights located at the intersection of taxiways Q and M, at the hold short line of taxiway M at the entrance to runway 18, and on runway 18 (near the position and hold location).

Controller subsystem 26 (which may be distributed about several processing units or the like) is responsive to interrogator unit 22 and activates one or more indicators 24a, 24b, and/or 24c if an incursion condition exists.

In one example, an airplane is detected on runway 18 and the red lights of indicator 24c are automatically illuminated to define that the runway is occupied. The location of the plane at, say, location 30a can be pinpointed by analyzing equivalent strength acoustic signals at “virtual microphone” locations 32a and 32b. In this way, ambiguities as between locations 30b and 30a can be resolved. The signals output by the virtual microphones are also compared to a library of signals to differentiate, for example, as between planes, vehicles, people, animals, and the like and also even to differentiate as between different types of aircraft. Once the plane in the above example is no longer detected on the runway, as would be the case if the plane took off, controller 26 automatically deactivates the red light(s) on indicator 24c.

The indicators can be wirelessly connected to controller 26 (typically located in the control tower) or signals can be sent via wired connections. Other indicators are, for example, as set forth in US Patent Publication No. 2003/0009278 and/or the article entitled “Runway Status Lights,” Tech Notes, Lincoln Laboratories (MIT).

In another example, a first airplane (or vehicle) is detected at location 30c but another second airplane is on a short final approach to runway 18. The red light of indicator 24c is illuminated by controller 26, after sensing the approaching aircraft on final. Then, the first airplane incorrectly ignores the red light condition and proceeds onto the runway. The sensing subsystem detects the presence of the first airplane at location 30a. Controller 26 now illuminates, or causes to blink, for example, the airport PAPI lights, the airport takeoff hold lights 24d, intersection lights, and the like providing a warning to the second landing airplane to execute a missed approach or a go-around.

In still another scenario, one object (a plane, vehicle, or the like) is detected at location 30c on taxiway M and another object is detected at location 30d on taxiway Q. In response, controller 26 automatically activates the red light(s) of indicator 24a. Once the object or vehicle on taxiway Q has proceeded down taxiway M, the controller deactivates the red light(s) of indicator 24a. Other common runway and taxiway incursion scenarios detected and prevented in accordance with the invention include an aircraft or vehicle crossing in front of a landing aircraft, an aircraft or vehicle crossing in front of an aircraft taking off, an aircraft or vehicle crossing the runway-holding position marking, an aircraft or vehicle unsure of its position and inadvertently entering an active runway, a breakdown in communications leading to failure to follow air traffic controller instructions, and/or an aircraft passing behind an aircraft or vehicle that has not vacated the runway.

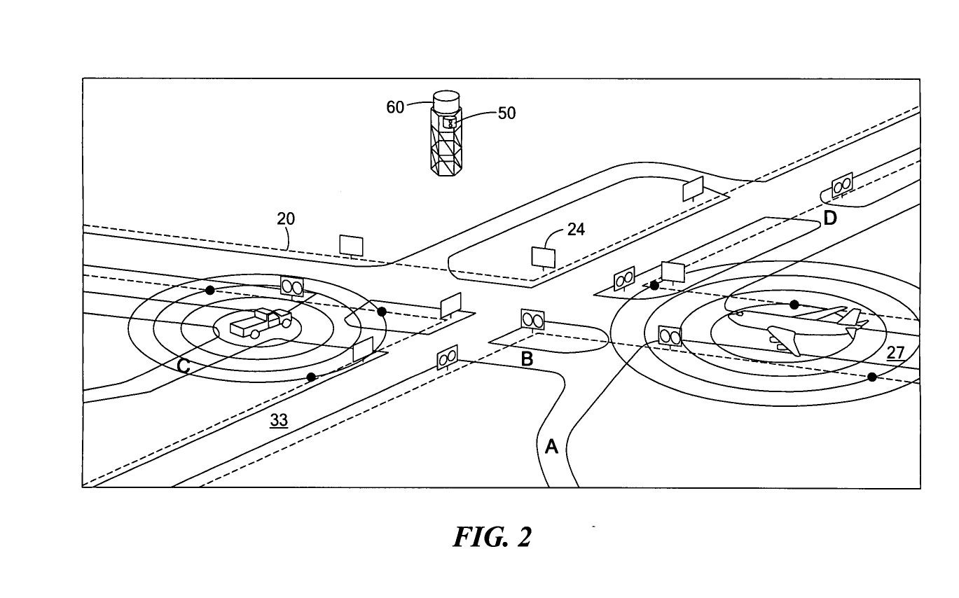

The system and method of the subject invention is scalable to larger airports where there are multiple and sometimes even parallel runways, multiple taxiways, multiple runway entrances, and the like. In the example shown in FIG. 2 there are intersecting runways 27 and 33 and multiple taxiways A, B, C, and D resulting in numerous intersections with multiple indicators 24. Preferably, the buried fiber optic cable 20 runs, to the extent allowed, at least along the majority of both sides of each runway.

FIG. 2 also shows the addition of high resolution imaging subsystem 50 and radar subsystem 60, a millimeter wave radar subsystem may be used. X band systems may also be used. The controller subsystem can be configured to activate the imaging subsystem in response to an incursion condition. Upon the confirmation and/or the non-confirmation of the imaging subsystem of an incursion condition, the controller subsystem may activate the radar subsystem. In one example, a camera can be made to automatically point to and focus on a given location upon receiving an alert enabling video analytics to make a comparison of stored baseline pictures to logged camera video at preset camera positions across the operation surface. The camera can be controlled to pan, tilt, zoom, and focus. The camera subsystem is typically a high camera which performs regular sweeps validating any potential risks of runway incursions, and/or to eliminate false alarms of the acoustic, sensing subsystem. A thermal camera may also be included. The camera subsystem can be used to detect aircraft in flight, objects, animals, or the like which are not detectable by the acoustic sensing subsystem. The camera can also be used to verify incursion alerts generated by the controller responding to the acoustic sensing subsystem and/or to radar data. The radar subsystem is typically a high resolution radar which performs regular sweeps validating any potential risks of runway incursions, and/or to eliminate false alarms of the acoustic sensing subsystem. Also, the high fidelity of this radar subsystem offers detection of objects such as planes, vehicles, personnel and wildlife.

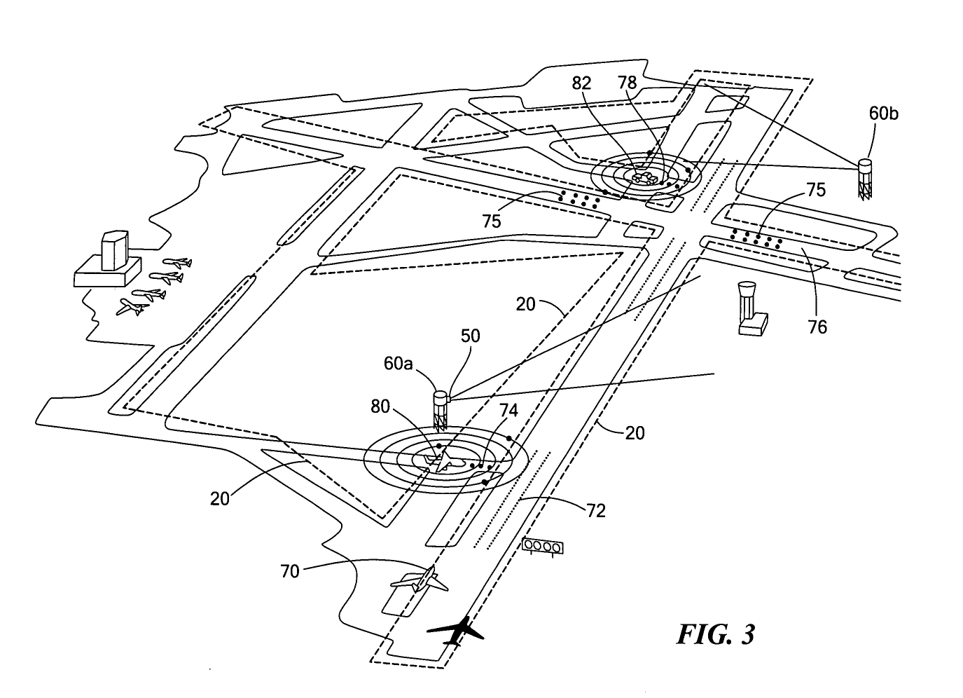

FIG. 3 shows yet another airport scenario, the location of buried optical fiber 20, and two millimeter wave installations 60a and 60b as well as camera installation 50. Here aircraft 70 is landing and the system has automatically rendered embedded runway lights 72 off, embedded taxiway lights 74 red, the embedded runway lights 75 of intersecting runway 76 red, taxiway lights 78 red, and the like. The acoustic sensing optical fiber has detected both the presence and location of aircraft 80 and vehicle 82. Millimeter wave subsystems 60a and 60b as well as camera subsystem 50 have confirmed the location and identity of aircraft 70, the location of aircraft 80, and the location of vehicle 82.

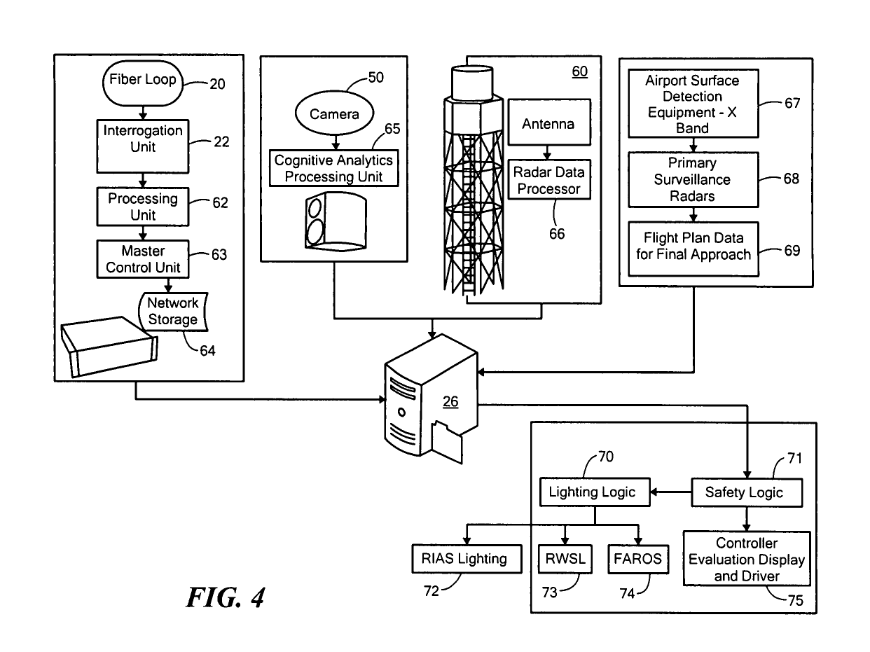

FIG. 4 shows the primary components associated with a complete system but note that as shown above with respect to FIG. 1 not all of these subsystems are necessarily required in every installation.

The fiber loop 20 is configured so sound waves introduce strain to the fiber optic creating backscatter to a laser with which frequency and amplitude can be measured. Interrogator Unit 22 measures the backscatter to determine frequency and amplitude. Computer 62 interprets signals sent to it from the interrogator unit and visually displays them via a user interface. Master Control Unit 63 is utilized when more than one processing unit is present to control multiple processors. Network storage 64 may be used to continuously record activity at the airport.

High resolution, night vision camera 50 takes visual shots of predetermined points on the runway for cognitive video analytics. Video Analytics processing unit 65 uses the camera data and analyzes changes in pixels to determine a change in conditions on the runway and to verify an acoustic alert. Antenna 60 sends and receives millimeter wave pulses to determine targets on the runway. Radar Data Processor 66 uses antenna data and analyzes changes to prior recorded information to determine a change in conditions on the runway and verify an acoustic and camera alert. Airport Surface Detection Equipment 67 is technology used for runway monitoring and incursion detection. Primary Surveillance Radar 68 is used to monitor traffic in and around an airport. Flight Plan Data for Final Approach 69 gives controllers the flight plan data for landing aircraft. RIAS Logic software 26 received input from the distributed acoustic sensing, camera, and millimeter wave radar system and possibly existing technologies to determine whether a runway incursion is occurring. Safety Logic software 71 drives the lighting logic to tell which lights to turn on or off depending on whether an incursion exists.

Lighting Logic software/relay/programmable logic controller system 70 drives the lights. The RIAS lighting 72 is similar to the light fixtures shown in FIG. 2. Runway Status Lights 73 (RWSL) are existing FAA lights embedded in the runway similar to those shown in FIG. 3. Final Approach Runway Occupancy Signal (FAROS) 74 notifies pilots on approach by flashing the PAPI lights or similar lighting. Controller Evaluation Display and Driver 75 is a display and computer which displays the system status.

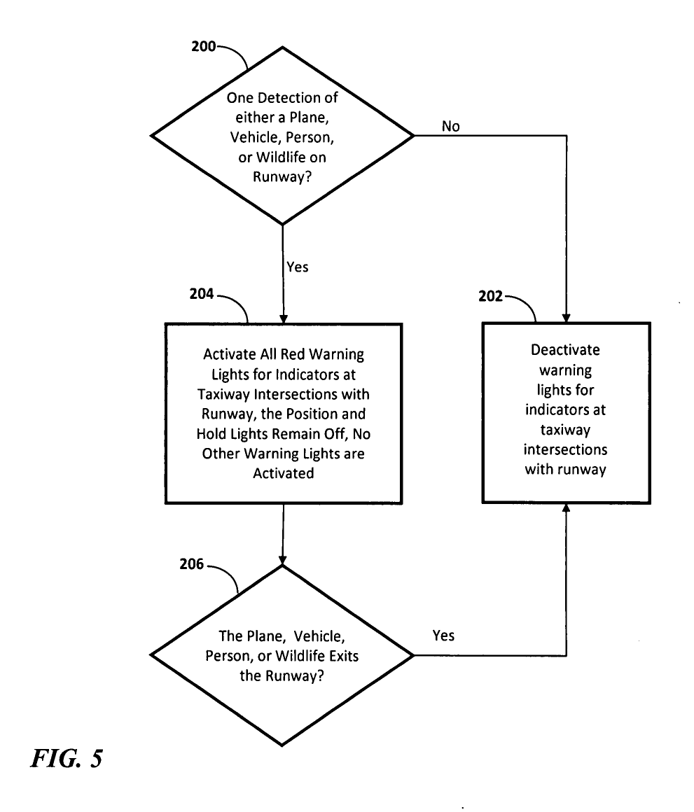

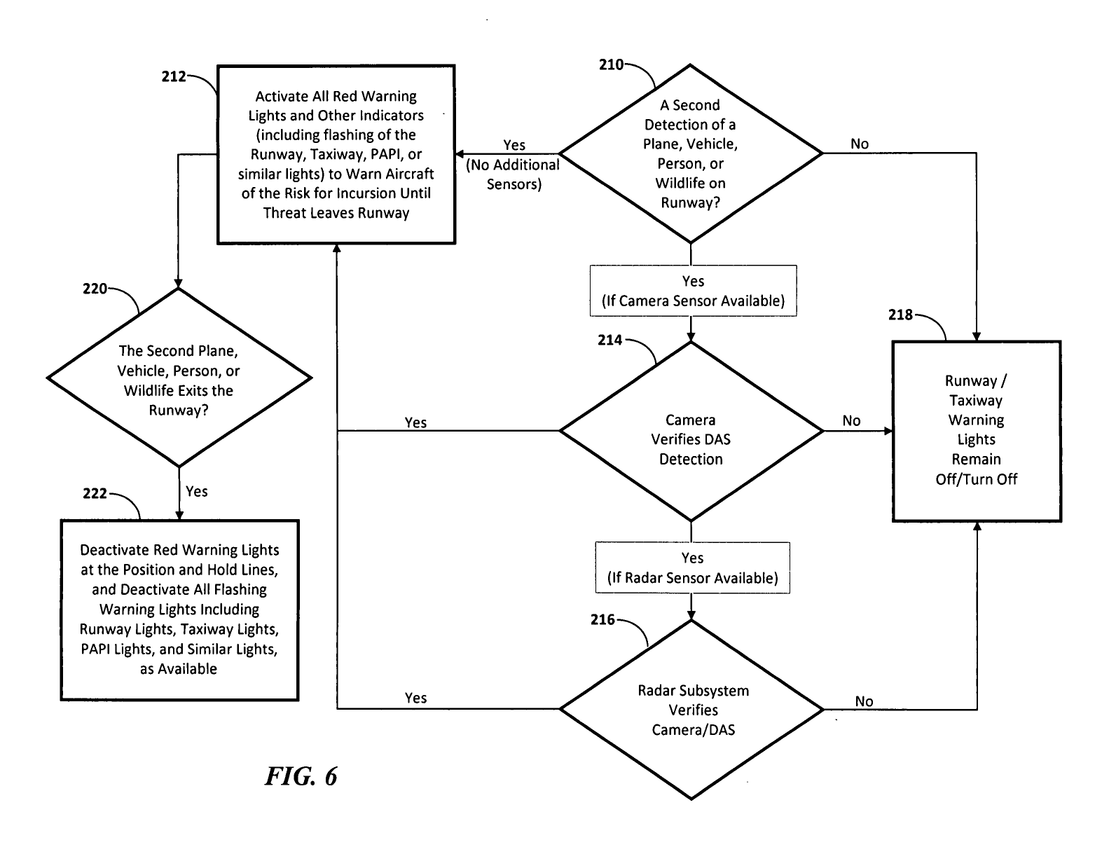

In one example in FIG. 4, the logic associated with controller subsystem 26, FIG. 4 is used to detect whether or not a plane is located on a given runway, step 200 FIG. 5. As noted above, the buried fiber optic loop in conjunction with interrogator unit 22, FIG. 4 comprising an acoustic sensing subsystem in accordance with the invention can be used to detect the location of a plane on a runway. If no plane is detected, the controlling logic of subsystem 26 will deactivate all red lights for the indicators at taxiways intersecting with that runway, step 202, FIG. 5. If, in contrast, a plane is detected on the runway at step 200, the controlling logic can be configured to activate all red warning lights for indicators at taxiways intersecting with that runway, step 204. In the same example, if the plane is detected as exiting the runway, step 206, FIG. 5, either by crossing onto another taxiway or by taking off from the runway, the controlling logic of subsystem 26 will deactivate all red lights, step 202, FIG. 5. Again, following the same example, if a second detection is made of a plane, vehicle, person, or wildlife, step 210, FIG. 6, all the runway based warning indicators such as embedded runway lights, the PAPI subsystem lights, and the like will turn red, or made to flash, step 212, to warn aircraft on the runway, including approaching aircraft, that an incursion risk had been detected on the runway. If additional sensors are present such as a camera and/or radar subsystem, each sensor will act as an additional verification of detection as available, before activation of warning lights, step 212, to reduce false alarms. Then, if the plane is detected as exiting the runway, step 220, either by crossing onto another taxiway or by taking off from the runway, the controlling logic of subsystem 26 will deactivate all red warning lights, step 222.

During installation, the fiber optic cable as shown in FIG. 1 at 20 is set along at least select taxiways and runways of the airport typically by burying the fiber optic cable and, to the greatest extent possible, refraining from having to cut into or dig into any taxiway or runway. The indicators are provided as shown and then the sensor subsystem is linked to the indicators in order to activate the indicators if an incursion condition exists as detected by the sensor subsystem.

This lower cost, scalable solution assists in the prevention of runway incursions by providing detection capability that can operate in all types of weather conditions, during the day or night, and does not require aircraft equipment installation, testing or certification. The buried fiber optic cable is not subject to damage and/or to adverse weather conditions since the operation of the buried fiber optic cable is not affected. If other alerting systems are present at the airport (for example the RWSL or FAROS systems), then those systems can also be used to provide an alert in the case of runway occupancy as detected by the acoustic sensing fiber optic cable. The imaging subsystem, if provided, can validate and detect the incorrect presence of an aircraft, vehicle, or person. The radar subsystem, if included, provides a second level of alert validation that automatically validates incorrect presence of an aircraft, vehicle or people, wildlife, and the like.

For example, if a vehicle, person, wildlife, or plane is detected on a runway, step 210, FIG. 6, the red warning lights for the runway and the taxiways (as appropriate) are activated until the threat leaves the runway or the PAPI lights flash to the planes on approach, step 212. In step 214, in the case where additional camera type sensor is employed as discussed herein, if the camera verifies the threat detected by the distributed acoustic sensing subsystem, then processing continues as discussed above with respect to step 212. As shown in block 216, if a radar subsystem verifies the output of the camera sensing subsystem and the distributed acoustic sensing subsystem, then again processing continues as shown in step 212. In the case where the camera detection subsystem does not agree with the distributed acoustic subsystem, then processing continues as shown at step 218 wherein the runway and taxiway warning lights remain or are turned off. The same is true when a radar subsystem is employed and does not agree with the analysis of the image (camera) detection subsystem or the distributed acoustic sensing subsystem.

The preferred indicator subsystem components can be viewed by pilots and vehicle operators at runway entry and crossing points to alert potential runway incursion risks through visual cues as noted above. Other optional components include displays for air traffic controllers, a database for event review and trend analysis, and preservation of a historical record of all potential incursion events.

The system is easily integrated with existing systems to augment their capability including sensors such as airport service detection equipment model X (ASDE-X) or low cost ground surveillance (LCGS) systems and visual display systems such as runway status lights (RWSL) and/or final approach runway occupancy signals (FAROS).

Therefore, although specific features of the invention are shown in some drawings and not in others, this is for convenience only as each feature may be combined with any or all of the other features in accordance with the invention. Also, the words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An airport incursion notification system comprising:
a fiber optic cable configured as an interferometric sensor to detect noise and buried adjacent to one or more select runways of an airport;
at least one interrogator unit for determining the location of and classifying noises detected by the fiber optic;
indicators at least located at select runway and taxiway intersections; and
a controller subsystem responsive to the interrogator unit and configured to activate one or more said indicators if an incursion condition exists.

2. The system of claim 1 in which the fiber optic cable is set along opposite sides of said select runways.

3. The system of claim 1 in which the indicators include above ground warning lights.

4. The system of claim 1 in which the indicators include runway entrance lights.

5. The system of claim 1 in which the indicators include take off hold lights.

6. The system of claim 1 in which the indicators include runway intersection lights.

7. The system of claim 1 in which the indicators include precision approach path indicator lights.

8. The system of claim 1 in which an incursion condition includes a plane on a runway and said controller subsystem is configured to activate indicators at taxiways intersecting with said runway in response.

9. The system of claim 1 in which an incursion condition includes an object on a runway and the controller subsystem is configured to activate runway based indicators in response.

10. The system of claim 1 in which an incursion condition includes a plane on a taxiway intersecting a runway and a plane, vehicle or other object detected on said runway and said controller subsystem is configured to activate an indicator at the taxiway where it intersects the runway.

11. The system of claim 1 further including a fiber optic cable buried adjacent to at least one taxiway of the airport.

12. The system of claim 11 in which an incursion condition includes a plane or vehicle on one taxiway and a plane or vehicle on an intersecting taxiway and the controller subsystem is configured to activate an indicator at said taxiway intersection.

13. The system of claim 1 further including a high resolution imager.

14. The system of claim 13 in which the controller subsystem is further configured to activate the high resolution imager in response to an incursion condition.

15. The system of claim 1 further including a radar subsystem.

16. The system of claim 15 in which the radar subsystem includes a millimeter wave or X band radar subsystem.

17. The system of claim 15 in which the controller subsystem is configured to activate the radar subsystem in response to an incursion condition.

18. An airport system comprising:
an acoustic sensor subsystem set along one or more select runways of an airport;
indicators located at least at select runway and taxiway intersections; and
a controller subsystem responsive to the acoustic sensor subsystem and configured to activate one or more said indicators if an incursion condition exists.

19. The system of claim 18 in which the acoustic sensor subsystem is set alongside said one or more runways.

20. The system of claim 19 in which the acoustic sensor subsystem is buried alongside said one or more runways.

21. The system of claim 18 in which the acoustic sensing subsystem includes a fiber optic cable configured as an interferometric sensor.

22. The system of claim 21 in which the fiber optic cable is set on opposite sides of said one or more select runways.

23. The system of claim 21 in which the acoustic sensing subsystem further includes at least one interrogator unit configured to detect the location of and classify noises detected by the fiber optic cable.

24. The system of claim 18 in which the indicators include above ground warning lights.

25. The system of claim 18 in which the indicators include runway entrance lights.

26. The system of claim 18 in which the indicators include take off hold lights.

27. The system of claim 18 in which the indicators include runway intersection lights.

28. The system of claim 18 in which the indicators include precision approach path indicator lights.

29. The system of claim 18 in which an incursion condition includes a plane on a runway and said controller subsystem is configured to activate indicators at taxiways intersecting with said runway in response.

30. The system of claim 18 in which an incursion condition includes an object on a runway and the controller subsystem is configured to activate runway based indicators in response.

31. The system of claim 18 in which an incursion condition includes a plane on a taxiway intersecting a runway and a plane, vehicle, or other object detected on said runway and said controller subsystem is configured to activate an indicator at the taxiway where it intersects the runway.

32. The system of claim 18 in which said acoustic sensor subsystem is set along one or more select taxiways of the airport.

33. The system of claim 32 in which an incursion condition includes a plane or vehicle on one taxiway and a plane or vehicle on an intersecting taxiway and the controller subsystem is configured to activate an indicator at said taxiway intersection.

34. The system of claim 18 further including a high resolution imager.

35. The system of claim 34 in which the controller subsystem is further configured to activate the high resolution imager in response to an incursion condition.

36. The system of claim 18 further including a radar subsystem.

37. The system of claim 36 in which the radar subsystem includes a millimeter wave or X band radar subsystem.

38. The system of claim 36 in which the controller subsystem is configured to activate the radar subsystem in response to an incursion condition.

39. An airport incursion notification method comprising:
setting along one or more select runways of an airport an acoustic sensor subsystem;
providing indicators located at least at select runway and taxiway intersections;
linking the acoustic sensor subsystem to the indicators; and
activating one or more said indicators if an incursion condition exists as detected by the acoustic sensor subsystem.

40. The method of claim 39 in which a fiber optic cable is buried alongside opposite sides of said one or more runways.

41. The method of claim 39 in which the indicators are configured as above ground warning lights.

42. The method of claim 39 in which an incursion condition includes a plane on a runway and in response indicators at taxiways intersecting with said runway are activated.

43. The method of claim 39 in which an incursion condition includes an object on a runway and in response runway based indicators are activated.

44. The method of claim 39 in which an incursion condition includes a plane on a taxiway intersecting a runway and a plane, vehicle or other object detected on said runway and in response an indicator at the taxiway where it intersects the runway is activated.

45. The method of claim 39 further including setting said acoustic sensor subsystem along one or more select taxiways of the airport.

46. The method of claim 45 in which an incursion condition includes a plane or vehicle on one taxiway and a plane or vehicle on an intersecting taxiway and in response an indicator at said taxiway intersection is activated.

47. The method of claim 39 further including providing a high resolution imager.

48. The method of claim 39 further including activating the high resolution thermal imager in response to an incursion condition.

49. The method of claim 47 further including providing a radar subsystem.

50. The method of claim 49 in which the radar subsystem includes a millimeter wave or X band radar subsystem.

51. The method of claim 49 further including activating the radar subsystem in response to an incursion condition.
